(19) United States
(12) Patent Application Publication
(10) Pub. No.: US 2006/0024067 A1
(43) Pub. Date: Feb. 2, 2006

(54) Optical I/O chip for use with distinct electronic chip

(76) Inventor: Elisabeth Marley Koontz, Dallas, TX (US)

Correspondence Address: TEXAS INSTRUMENTS INCORPORATED, P O BOX 655474, M/S 3999, DALLAS, TX, 75265, US

(21) Appl. No.: 10/901,828

(22) Filed: Jul. 28, 2004

(51) Int. Cl. H04B 10/04

(52) U.S. Cl. 398/183

(57) ABSTRACT

Generally, an embodiment of the present invention provides an optical input/output (I/O) chip that is fabricated separately and distinctly from an electrical integrated circuit chip having core circuitry thereon. The electronic and optical I/O chips are later electrically connected (e.g., using packing technology) to form a hybrid optical-electronic chip system that utilizes optical I/O components on the optical I/O chip to communicate at least some of the I/O signals into and out of the electrical integrated circuit on the distinct electronic chip.

### TECHNICAL FIELD

The present invention relates generally to the use of optical signals to transmit signals and data to and/or from an electronic chip.

### BACKGROUND

For many semiconductor integrated circuits, management of the input/output (I/O) data rate versus pin count is a significant challenge. The I/O speeds are typically lower than speeds at which the integrated circuit core operates. In such cases, system designs often incorporate a large number of I/O pins as an acceptable design choice. Generally, lower speed I/O paths require less on-chip circuitry and less power for operation, which often makes parallel I/O solutions a preferred design choice. For cases where pin count management is an issue, higher speed on-chip I/O circuitry is typically used to provide I/O speeds in the range of a few gigahertz. The high-speed I/O designs, however, usually require additional power consuming circuitry (typically analog), for which extra attention is needed to design for parasitic matching (e.g., between bond pads, solder balls and/or wire bonds, package substrate, package leads, etc.) and for signal integrity. Wireline loss generally increases with frequency. Hence, a need exists for improved ways of providing high speed I/O data rates for integrated circuit chips.

Relying on an electrical path for I/O communication into/out of a chip at high frequencies (e.g., >2 GHz) requires much effort to minimize capacitance, to match impedance, and to efficiently transfer (i.e., with less loss) the electrical signals along a dedicated wireline. Some commonly proposed designs for using optical I/O arrangements for getting data and/or clock signals into or out of an electronic chip include having many individual lasers or modulators in combination with individual detectors bonded to electrical bond pads on a surface of an electrical integrated circuit (IC) chip. While this scheme is beneficial in that the emitters/modulators and detectors may be accurately placed anywhere on the surface of the IC chip, many pick-and-place operations are required to fully assemble the integrated device. Packaging has also been a major contributor to the signal integrity reduction in high-speed data transfer. An optical I/O arrangement may also reduce the contribution of signal integrity reduction due to packaging issues.

An alternative solution proposed is to embed emission/modulation and detection devices within the silicon IC chip in a monolithic manner. A technical barrier to this scheme, however, is the poor light emission properties of silicon. Also, it is currently cost prohibitive to fully utilize the chip real estate for transistors when emitters/modulators and detectors are also designed into the circuit, which may be counter to integration cost curves expected in the semiconductor IC industry. Furthermore, the processing steps may be quite different or incompatible for forming the optical components in comparison to forming the electrical components. For example, fabrication resolution, layer materials, layer thickness, and layer quality are typically different for electronic and photonic devices. Another factor that makes monolithic solutions technically difficult is that a laser emitter is typically very sensitive to temperature changes. A laser emitter on the IC chip may experience large temperature fluctuations during the use and non-use cycles of the electrical IC components, which may make the characteristics of the laser output vary. Such variations may lead to inconsistent light signals, which are technically difficult to account for and design around. Even in cases where an IC chip does not vary in temperature much (if any) during operation (e.g., some high-speed IC chips remain at a steady temperature of about 125° C.), the heat levels generated in an IC chip may cause problems for a laser device. For example, many category III-V laser devices are designed to operate at temperatures up to about 75° C. to provide a normal lifespan for the device. Long term exposure of the laser device to temperatures of about 125° C., for example, is likely to significantly reduce the lifetime of the laser device. Thus, the long term reliability of a laser source integrated into a high-speed IC chip becomes a issue (e.g., especially for vertical cavity lasers, which to date are often utilized in optical I/O demonstrations). Hence, monolithic solutions may not be economically and/or technically feasible. Thus, a need exists for providing a more economically and technically feasible solution to providing optical I/O for an electrical IC.

### SUMMARY OF THE INVENTION

The problems and needs outlined above may be addressed by embodiments of the present invention. In accordance with one aspect of the present invention, an optical input/output (I/O) chip adapted to be electrically coupled to a distinct electronic chip is provided. The optical I/O chip includes an optical input port, an input optical detector, an input electrical contact, an output light-source port, an output optical modulator, an output electrical contact, and an optical output port. The optical input port is adapted to be optically coupled to an external optical input source and is adapted to receive optical input signals into the optical I/O chip from the external optical input source. The input optical detector is optically coupled to the optical input port so that optical input signals entering the optical I/O chip via the optical input port are received by the input optical detector. The input optical detector is adapted to convert optical input signals to respective electrical input signals. The input electrical contact is electrically coupled to the input optical detector. The input electrical contact is adapted to be electrically coupled to the electronic chip for providing electrical input signals thereto. The output light-source port is adapted to be optically coupled to an external light source. The output optical modulator is optically coupled to the output light-source port. The output optical modulator is adapted to convert electrical output signals to respective optical output signals. The output electrical contact is electrically coupled to the output optical modulator. The output electrical contact is adapted to be electrically coupled to the electronic chip for receiving electrical output signals therefrom. The optical output port is optically coupled to the output optical modulator. The optical output port is adapted to be optically coupled to an external output signal receiving device.

In accordance with another aspect of the present invention, an optical I/O chip adapted to be electrically coupled to a distinct electronic chip is provided. The optical I/O chip includes an optical input port, an input optical detector, an input electrical contact, an output light-source port, an output optical modulator, an output electrical contact, an optical output port, an optical clock port, a clock optical detector, and a clock electrical contact. The optical input port is adapted to be optically coupled to an external optical input source and is adapted to receive optical input signals into the optical I/O chip from the external optical input source. The input optical detector is optically coupled to the optical input port so that optical input signals entering the optical I/O chip via the optical input port are received by the input optical detector. The input optical detector is adapted to convert optical input signals to respective electrical input signals. The input electrical contact is electrically coupled to the input optical detector. The input electrical contact is adapted to be electrically coupled to the electronic chip for providing electrical input signals thereto. The output light-source port is adapted to be optically coupled to an external light source. The output optical modulator is optically coupled to the output light-source port. The output optical modulator is adapted to convert electrical output signals to respective optical output signals. The output electrical contact is electrically coupled to the output optical modulator. The output electrical contact is adapted to be electrically coupled to the electronic chip for receiving electrical output signals therefrom. The optical output port is optically coupled to the output optical modulator. The optical output port is adapted to be optically coupled to an external output signal receiving device. The optical clock port is adapted to be optically coupled to an external optical clock source and adapted to receive optical clock signals into the optical I/O chip from the external optical clock source. The clock optical detector is optically coupled to the optical clock port so that optical clock signals entering the optical I/O chip via the optical clock port are received by the clock optical detector. The clock optical detector is adapted to convert optical clock signals to respective electrical clock signals. The clock electrical contact is electrically coupled to the clock optical detector. The clock electrical contact is adapted to be electrically coupled to the electronic chip for providing electrical clock signals thereto.

In accordance with yet another aspect of the present invention, an optical I/O chip adapted to be electrically coupled to a distinct electronic chip is provided. The optical I/O chip includes an optical I/O port, an optical coupler, an input optical detector, an input electrical contact, an output light-source port, an output optical modulator, and an output electrical contact. The optical I/O port is adapted to be optically coupled to at least one external optical component. The optical coupler is optically coupled to the optical I/O port. The input optical detector is optically coupled to the optical coupler so that optical input signals entering the optical I/O chip via the optical input port may be routed to and received by the input optical detector via the optical coupler. The input optical detector is adapted to convert optical input signals to respective electrical input signals. The input electrical contact is electrically coupled to the input optical detector. The input electrical contact is adapted to be electrically coupled to the electronic chip for providing electrical input signals thereto. The output light-source port is adapted to be optically coupled to an external light source. The output optical modulator is optically coupled to the output light-source port. The output optical modulator is adapted to convert electrical output signals to respective optical output signals. The output optical modulator also is optically coupled to the optical coupler such that optical output signals from the output optical modulator may be routed to the optical I/O port via the optical coupler. The output electrical contact is electrically coupled to the output optical modulator. The output electrical contact is adapted to be electrically coupled to the electronic chip for receiving electrical output signals therefrom.

In accordance with still another aspect of the present invention, a hybrid optical-electronic chip system is provided, which includes an electronic chip and an optical I/O chip, which are two distinct chips. The electronic chip includes an integrated electrical circuit, a first input electrical contact, and a first output electrical contact. The integrated electrical circuit is adapted to perform electronic functions. The first input electrical contact is electrically coupled to the integrated electrical circuit. The first output electrical contact is electrically coupled to the integrated electrical circuit. The optical I/O chip includes an optical input port, an input optical detector, a second input electrical contact, an output light-source port, an output optical modulator, a second output electrical contact, and an optical output port. The optical input port is adapted to be optically coupled to an external optical input source and is adapted to receive optical input signals into the optical I/O chip from the external optical input source. The input optical detector is optically coupled to the optical input port so that optical input signals entering the optical I/O chip via the optical input port are received by the input optical detector. The input optical detector is adapted to convert optical input signals to respective electrical input signals. The second input electrical contact is electrically coupled to the input optical detector. The second input electrical contact is electrically coupled to the first input electrical contact of the electronic chip for providing electrical input signals to the electronic chip. The output light-source port is adapted to be optically coupled to an external light source. The output optical modulator is optically coupled to the output light-source port. The output optical modulator is adapted to convert electrical output signals to respective optical output signals. The second output electrical contact is electrically coupled to the output optical modulator. The second output electrical contact also is electrically coupled to the first output electrical contact of the electronic chip for receiving electrical output signals from the electronic chip. The optical output port is optically coupled to the output optical modulator. The optical output port is adapted to be optically coupled to an external output signal receiving device.

The foregoing has outlined rather broadly features of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a simplified schematic showing a side view of an optical I/O chip that is electrically coupled to a distinct electronic chip in accordance with a first embodiment of the present invention;

FIG. 2 shows a simplified schematic of the optical I/O chip of FIG. 1;

FIG. 3 shows a simplified schematic of an optical modulator;

FIG. 4 shows a driver circuit that may be used in an embodiment of the present invention for providing an output electrical signal from the electronic chip to a modulator/emitter;

FIG. 5 shows a simplified schematic of an optical detector;

FIG. 6 shows a receiver circuit that may be used in an embodiment of the present invention for providing an input electrical signal from the optical detector to the electronic chip;

FIG. 7 shows a simplified schematic of an optical I/O chip of a second embodiment; and

FIG. 8 shows a simplified schematic of an optical I/O chip of a third embodiment.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Generally, an embodiment of the present invention provides an optical I/O chip that is fabricated separately and distinct from the electrical IC chip having the core circuitry thereon. The electrical and optical chips are later electrically connected to form a device that utilizes optical I/O components on the optical I/O chip to communicate at least some of the signals into and out of the electrical IC on the distinct electronic chip.

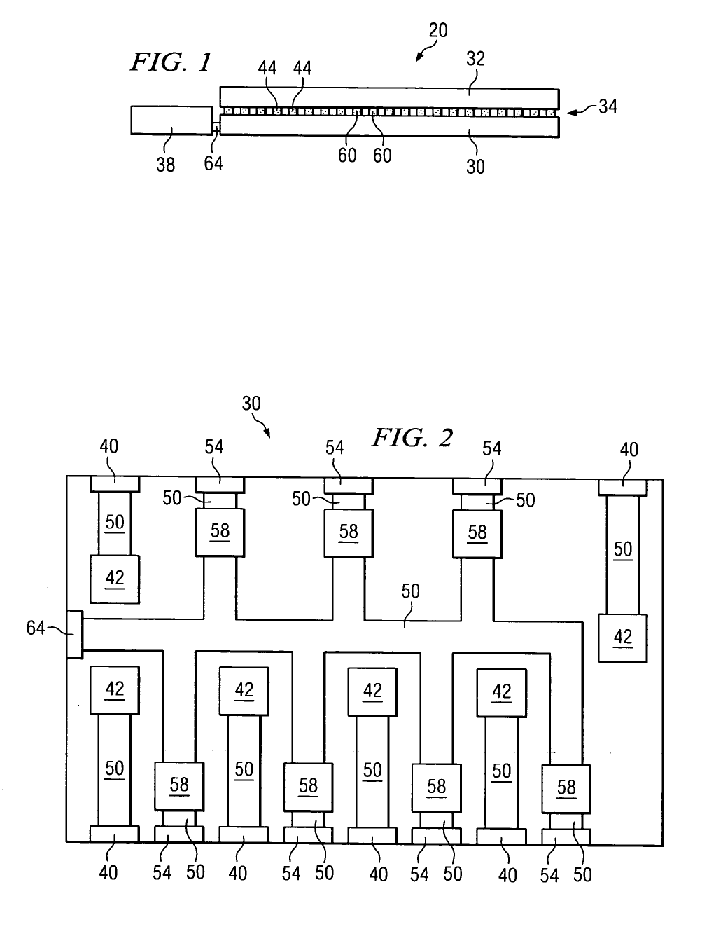

FIG. 1 is a simplified schematic showing a side view of an optical-electronic hybrid chip system 20 having an optical I/O chip 30 electrically coupled to a distinct electronic chip 32 in accordance with a first embodiment of the present invention. In the first embodiment, a flip-chip configuration is used, for example, to provide the electrical coupling between the two chips 30, 32. For example, an array of solder bumps 34 may be used in a flip-chip arrangement. The electronic chip 32 and the optical I/O chip 30 will often reside on a same printed circuit board.

As is preferred, an external light source 38 is optically coupled to the optical I/O chip 30 in the first embodiment. It is preferred to provide an external light source 38 for modulators on the optical I/O chip 30 to keep the light source further removed from temperatures greater than permissible for longevity of an optical device and/or heat fluctuations experienced by the electrical chip 32. Typically such a light source 38 is a laser device adapted to output a precise wavelength. The actual wavelength emitted by a laser of such precision and such size is often highly dependent on the temperature of the laser device. In other words, the wavelength emitted by a laser device (in such applications) typically varies as the temperature of the laser device varies. Usually, the waveguides formed in and/or on a chip 30 have specific and precise dimensions designed for a specific and narrow wavelength band of light. Thus, the wavelength of light provided by a light source 38 of such devices is often critical. In other embodiments, however, the light source 38 may be part of the optical I/O chip 30 rather than being external. Preferably, the light source is shielded from the heat fluctuations of the electrical IC chip 32 to at least some extent. Thus, an advantage of an embodiment of the present invention is that the light source 38 for the optical modulators may be external to the optical and/or electronic chips 30, 32, and/or completely external to and remote from the device 20. Using an external light source allows a laser source to be controlled and temperature stabilized independently of the IC and/or a linecard on which the IC resides.

FIG. 2 shows a simplified schematic of the optical I/O chip 30 of the first embodiment. The optical I/O chip 30 of FIG. 2 has a set of optical input ports 40, which are adapted to be optically coupled to an external optical input source (not shown in FIG. 2). For example, when the optical I/O chip 30 is operably installed, one of the optical input ports 40 may be optically coupled to a fiber optic cable that is optically coupled to a controller device (e.g., on a motherboard). Hence, in such example, the controller device is the external optical input source for that optical input port 40. Other optical input ports 40 may be optically coupled to other types of devices, including (but not limited to): a memory device, a memory buffer, a bus, a video card, a sound card, a peripheral device, a communication device, a switch, a clock, or a processor, for example.

A set of input optical detectors 42 are optically coupled to the set of optical input ports 40. Although only one detector 42 is shown optically coupled to each of the optical input ports 40 in FIG. 2, there may be more than one detector 42 optically coupled to an optical input port 40 and/or there may be more than one optical input port 40 optically coupled to a detector 42 in an embodiment. The input optical detectors 42 receive optical input signals that enter the optical I/O chip 30 via the optical input ports 40 and convert the optical input signals to electrical input signals. These electrical input signals are then routed to the electronic chip 32 via input electrical contacts 44 (see FIG. 1), as discussed in more detail below. The input electrical contacts 44 are electrically coupled to the input optical detectors 42 and are adapted to be electrically coupled to the electronic chip 32, as illustrated schematically in FIG. 1, for providing electrical input signals to the electronic chip 32. Any suitable packaging scheme may be used in an embodiment to provide the electrical connections between the optical I/O chip 30 and the electronic chip 32, including (but not limited to): solder bumps, solder balls, flip chip packaging, an interposer lead frame, pins, leads, wire bonds, wire bonded studs, and combinations thereof, for example. In a preferred embodiment, the detectors 42 are located directly above or close to the input electrical contacts 44 in an effort to minimize the effective electrical wire lengths between the optical I/O chip 30 and the electronic chip 32. One of the goals of an embodiment may be to minimize or significantly reduce wire line losses, RC delay, and inefficiencies for electrical signals traveling into and/or out of the electronic chip 32, especially for high frequency devices (e.g., >1 GHz) and high data transfer rates (e.g., 20 gigabits per second). Because the signal losses at gigabit transfer rates are much lower in an optical transmission of data than electrical, an objective of using an embodiment may be to maximize the use of optical data transmission between devices. Thus, an embodiment of the present invention may provide technology needed in future chips to achieve operating speeds greater than or much greater than a few gigahertz and/or data transfer rates of 20 gigabits per second and higher.

Often there will be an optical waveguide 50 between an input optical detector 42 and an optical input port 40 (see e.g., FIG. 2), such that the input optical detector 42 is optically coupled to the optical input port 40 via the optical waveguide 50. The structure and materials of an optical waveguide 50 may vary. For example, an optical waveguide may be a channel of Si and/or SiGe material formed in or on the optical I/O chip. In another example, however, the optical waveguide 50 may include a fiber optic cable (e.g., glass, polymer), for example.

Still referring to FIG. 2, a set of optical output ports 54 are shown, which are adapted to be optically coupled to an external output signal receiving device (not shown in FIG. 2). For example, when the optical I/O chip 30 is operably installed, one of the optical output ports 54 may be optically coupled to a fiber optic cable that is optically coupled to a video card (e.g., on a motherboard). Hence, in such example, the video card is the external signal receiving device for that optical output port. Other optical output ports may be optically coupled to other types of devices, including (but not limited to): a memory device, a memory buffer, a bus, a controller, a sound card, a peripheral device, a communication device, a switch, a clock, or a processor, for example.

A set of output optical modulators 58 are optically coupled to the set of optical output ports 54. Although only one modulator 58 is shown optically coupled to each of the optical output ports 54 in FIG. 2, there may be more than one modulator 58 optically coupled to an optical output port 54 and/or there may be more than one optical output port 54 optically coupled to a modulator 58 in an embodiment. The output optical modulators 54 are adapted to convert electrical output signals (coming from the electronic chip 32) to corresponding optical output signals. The optical output signals are then output to an external signal receiving device via an optical output port 54.

Output electrical contacts 60 are electrically coupled to the modulators 58 and are adapted to be electrically coupled to the electronic chip 32, as illustrated schematically in FIG. 1, for providing electrical output signals to the optical I/O chip 30 from the electronic chip 32. As with the input electrical contacts 44, any suitable packaging scheme may be used in an embodiment to provide the electrical connections between the optical I/O chip 30 and the electronic chip 32 via the output electrical contacts 60. In a preferred embodiment, the modulators 58 are located directly above or close to the output electrical contacts 60 in an effort to minimize the effective electrical wire lengths between the optical I/O chip 30 and the electronic chip 32 (as described above regarding placement of detectors 42). Thus, it may be desirable to design an electronic chip 32 and the optical I/O chip 30 in a coordinated manner to allow for minimum effective wire lengths and/or minimized wire line losses. In other embodiments, however, the optical I/O chip 30 or the electronic chip 32 may be designed independently (e.g., as a modular device) to match an existing chip.

In FIG. 2, the optical I/O chip 30 of the first embodiment has an output light-source port 64, which is optically coupled to the modulators 58 via optical waveguides 50. The optical light-source port 64 is adapted to be optically coupled to an external light source 38 (e.g., a laser) (see e.g., FIG. 1). Hence, in the first embodiment, an external light source 38 provides light for the modulators 58. Although a single external light source 38 is used in the first embodiment of FIGS. 1 and 2, there may be multiple output light sources 38 (e.g., external and/or on the optical I/O chip 30) in other embodiments. In other embodiments, one or more of the modulators 58 may be substituted with emitters. An emitter is typically a laser device or a light emitting diode adapted to convert an output electrical signal to an output optical signal.

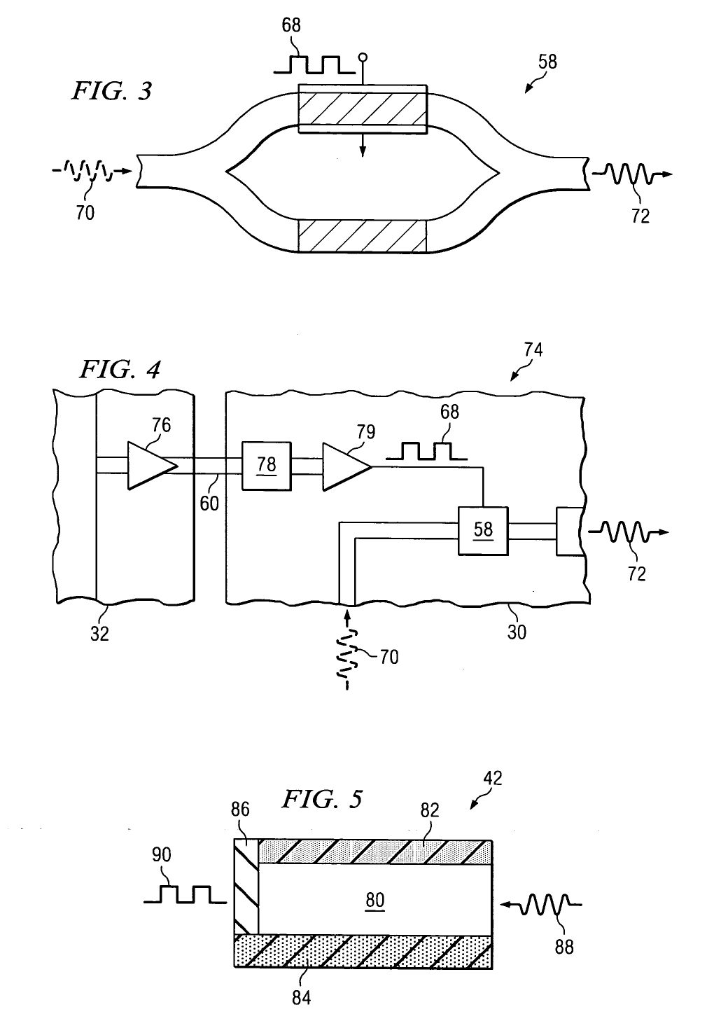

In a preferred embodiment, a modulator 58 is a SiGe optical modulator with a multiple quantum well in a Mach-Zehnder interferometer, as schematically illustrated in FIG. 3. For example, the modulator 58 of FIG. 3 may be adapted to receive a single ended one-volt swing signal 68 (e.g., two levels: 0 volt bias and −1 volt reverse bias), with about 50 ohms load, and with a carrier escape time of about 10 picoseconds. Such electrical signal 68 is then used by the modulator to modify an initial light 70 from the external light source 38 and output an optical output signal 72.

FIG. 4 shows a driver circuit 74 that may be used in an embodiment of the present invention for providing an output electrical signal 68 from the electronic chip 32 to a modulator 58. In this example driver circuit 74, a differential pair with a low voltage output is used to transfer electrical signals from the electronic chip 32 to the modulator 58. Output electrical signals are provided to a single-ended-to-differential driver 76, which outputs a differential signal (e.g., at about 1 volt bias). A biasing device 78 on the optical I/O chip 30 receives the differential signal, and a differential-to-single-ended driver 79 on the optical I/O chip 30 provides the output electrical signal 68 to the modulator 58. The modulator 58 then converts the output electrical signal 68 to an output optical signal 72 using light 70 from light source 38. As will be apparent to one of ordinary skill in the art, other electrical schemes may be used for transmitting the output electrical signal from the electronic chip 32 into the optical I/O chip 30. Also, as mentioned above, the modulator 58 in FIG. 4 may be substituted with an emitter (not shown).

The structure, type, and materials used in an input optical detector 42 may vary, as there are many possible optical detector designs. In a preferred embodiment, an input optical detector 42 may have a structure like that shown in FIG. 5. The example input optical detector 42 shown in FIG. 5 is a SiGe planar photodetector device, which may be designed to operate with reverse bias of about 5 volts, about 10-20 nA dark current, about 0.2 pF capacitance, at about 10.5 GHz bandwidth, and with about 25-29% efficiency, for example. The input optical detector 42 of FIG. 5 has a SiGe absorption region 80 sandwiched between a P+ doped silicon contact layer 82 and an N-doped silicon layer 84. An oxide layer 86 is formed adjacent to the SiGe absorption region 80 and over the N-doped silicon layer 84 in this example. The detector 42 of FIG. 5 is thus adapted to receive an optical input signal 88 in the SiGe absorption region 80 and convert it to a corresponding electrical input signal 90 (as illustrated schematically in FIG. 5).

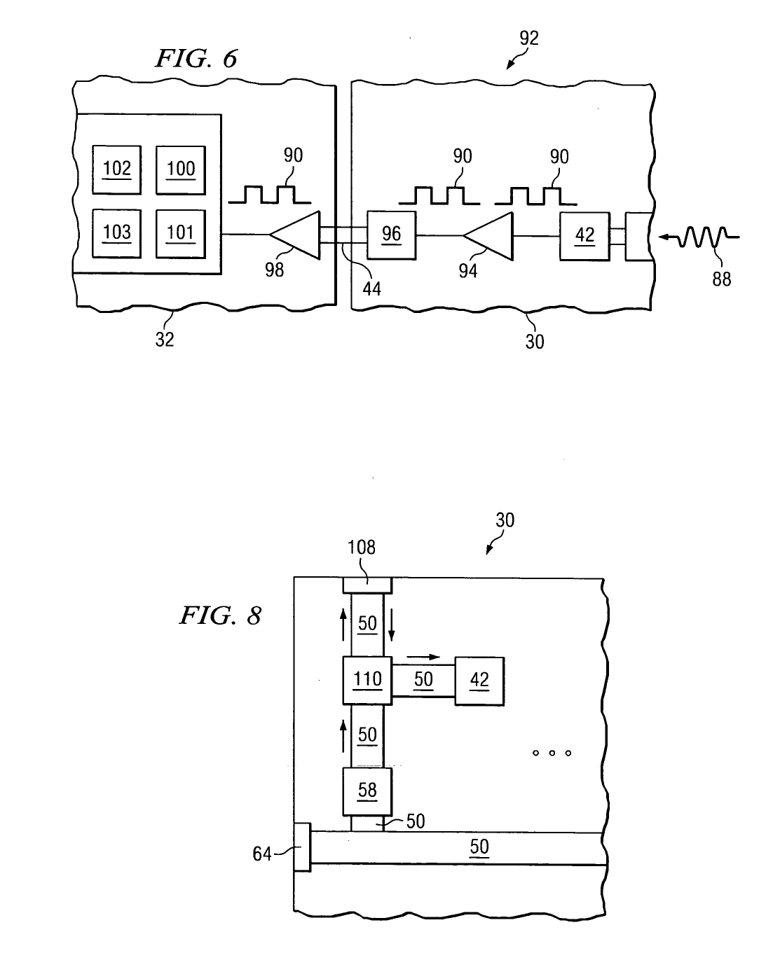

FIG. 6 shows a receiver circuit 92 that may be used in an embodiment of the present invention. In FIG. 6, a detector 42 is electrically coupled to a transimpedance amplifier 94 and a single-ended-to-differential driver 96, both of which are located on the optical I/O chip 30 in this case. The transimpedance amplifier 94 boosts the electrical input signal 90 from the optical detector 42, which may be very small, and it passes the boosted electrical input signal 90 to the driver 96. The driver 96 creates a differential pair of signals and sends the input electrical signal across the electrical contacts 44 to the electronic chip. On the electronic chip 32 a differential-to-single-ended receiver 98 may output the input electrical signal 90 to a component or device on the electronic chip 32, such as an offset controller 100, a LOS 101, a CDR 102, and/or a signal detector device 103, for example. As is well known, differential signals are preferred for electrical transfer between devices to protect the signal integrity.

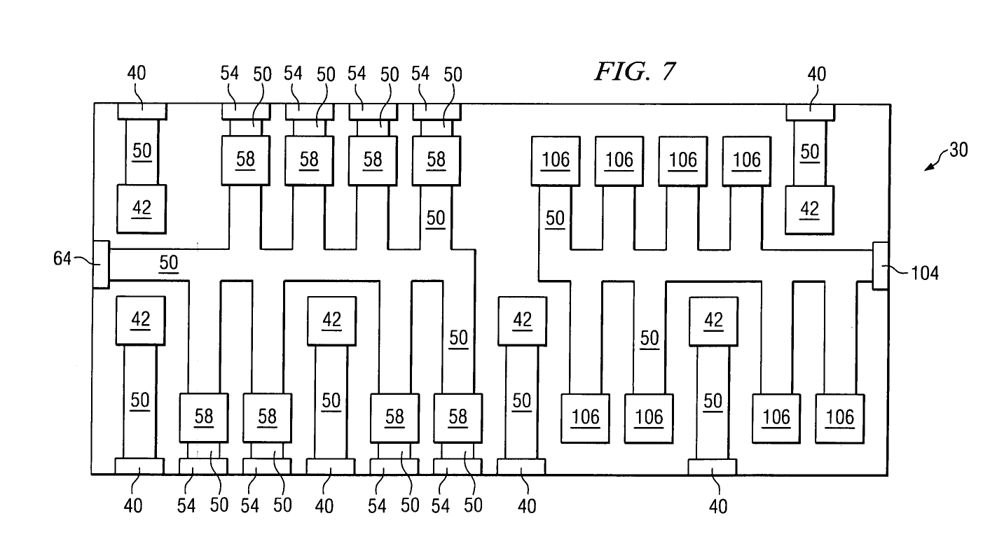

FIG. 7 shows a simplified schematic of an optical I/O chip 30 of a second embodiment. The optical I/O chip 30 of FIG. 7 is similar to that of the first embodiment (FIG. 2) in that it has a set of optical input ports 40, a set of input optical detectors 42, a set of optical output ports 54, a set of output optical modulators 58, and an output light-source port 64. In addition, the second embodiment includes an optical clock port 104 and clock optical detectors 106. The optical clock port 104 is adapted to be optically coupled to an external optical clock source (e.g., clock circuitry). The clock optical detectors 106 are optically coupled to the optical clock port 104 via optical waveguides 50, so that optical clock signals coming into the optical I/O chip 30 via the optical clock port 104 are received by the clock optical detectors 106. The clock optical detectors 106 are adapted to convert an optical clock signal to an electrical clock signal. Clock electrical contacts, which may be like those of the input and output electrical contacts 44, 60 (discussed above), are electrically coupled to clock optical detectors 106 for providing the electrical clock signals to the electronic chip 32.

FIG. 8 shows a simplified schematic of an optical I/O chip 30 of a third embodiment. In the third embodiment, optical I/O ports 108 are used for optically coupling the optical I/O chip 30 to one or more external optical components (not shown in FIG. 8). The design of the third embodiment allows for input and output (bidirectional) optical signals to pass through a same optical I/O port 108. The optical I/O port 108 is optically coupled to an optical coupler 110 on the optical I/O chip 30 (e.g., directly or indirectly via an optical waveguide 50). The optical coupler 110 is also optically coupled to an input optical detector 42 and an output optical modulator 58. The optical coupler 110 may be directional and/or wavelength specific, for example. Typically in a third embodiment, there will be multiple groups of these components (the optical I/O port 108, the optical coupler 110, the input optical detector 42, and the output optical modulator 58), as indicated by “ . . . ” in FIG. 8. Only one group of such components is shown in FIG. 8 for purposes of simplifying the drawing.

Another advantage of an embodiment of the present invention is that an optical I/O port 108 may take advantage of the fact that light beams—even if of identical wavelength—do not interfere if traveling in opposite directions. Thus, input and output may be occurring simultaneously or overlapping on a same waveguide 50 or through a same port 108. Also, multiple wavelengths of light may be used for multiple signals being transferred through a single port or waveguide. For example, a clock signal may be transmitted at a first wavelength and a data signal may be transmitted at a second, different wavelength across a same line or light path.

In a variation on the third embodiment of FIG. 8, a modulator 58 may be replaced with an emitter. As another variation on the third embodiment, one optical coupler 110 may be optically coupled to one or more input optical detectors and/or one or more modulators/emitters. Also, one optical detector may be optically coupled to more than one optical coupler 110, and/or one modulator/emitter may be optically coupled to more than one optical coupler 110. Furthermore, components of the first, second, and third embodiments may be combined in various ways to provide other embodiments of an optical I/O chip of the present invention.

I/O data transfer rates into and/or out of a chip are becoming or already are a major bottleneck for increasing chip speeds above a few gigahertz and/or increasing data transfer above about 10 gigabits per second. Hence, an embodiment of the present invention may provide an advantage of addressing (e.g., lessening restriction of) or eliminating such bottlenecks for data transfer rates into or out of an electronic chip 32. Target data rates for an embodiment may be 20 gigabits per second and higher, for example, over more than 100 high speed I/O pins. Also, as more and more circuits, computer systems, and communications systems use optical means of transferring data, an embodiment of the present invention may be particularly useful in integrating an electronic chip 32 with such optical systems or components.

The manufacturing processes and steps used in fabricating electrical components and optical components are often quite different and varied. Thus, attempting to fabricate electrical components and optical components on a same substrate or same chip is often not cost effective and/or processing steps/materials may conflict with each other. Such issues have made it difficult (technically and cost-wise) to incorporate optical input and output of data into and out of an IC chip. An advantage of the present invention is that the optical components may be fabricated on the optical I/O chip 30 separately and distinctly from the electronic chip 32, and vice versa for the core electrical components. Also, by providing distinct chips for optical I/O and core electrical components, the electronic chip 32 may use non-light emitting/transmitting materials. Moreover, providing distinct chips for optical I/O and core electrical components will allow optical chip research (e.g., materials, processing) to branch off and progress independently from that of electronic chips 32. Another advantage is that optical I/O chips 30 may be manufactured and sold separately (e.g., by different manufacturers or at different fabrication facilities) than that of the electronic chips 32. Standards may be developed for the electrical contacts between the optical I/O chips 30 and the electronic chips 32 so that a buyer may select from multiple optical I/O chip makers to interface with a same electronic chip 32. Also, a same electronic chip 32 may be integrated into different systems using different optical I/O chips 30. Thus, an embodiment of the present invention may provide for increased modularity among chips for use in many different combinations and applications.

Furthermore, chip packaging processes, designs, and techniques have dramatically improved in recent years. For example, the number of contacts or the pin count between chips has increased, the accuracy and reliability of the connections (e.g., chip to substrate/board) have improved, and the structural and mechanical integrity and reliability of such connections have improved in recent years. An embodiment of the present invention preferably makes use of such improvements to achieve the cost and reliability advantages associated with such packaging processes and designs. It will likely be more cost effective to produce the optical components on a separate and distinct chip 30 from the core electrical components, as an embodiment of the present invention provides, than trying to put such components on a single chip. Even though some active electrical circuits may be integrated into the optical I/O chip 30 (e.g., heterojunction bipolar transistor, biasing components, amplifiers, regulators), the majority of the core electrical IC's (e.g., digital portions) will likely be located on the electronic chip 32.

It is contemplated that future implementations or embodiments may be used in portable devices or portable applications. Power consumption by devices is especially important in portable devices that are powered by batteries, for example. Another advantage of an embodiment of the present invention may be a reduction of power needed for I/O data transfer into and out of the electronic chip 32 because electrical power losses from such transfers may be significantly reduced with the use of an optical I/O chip 30.

Another advantage is that an embodiment of the present invention may be designed to optically interface directly at standard telecommunication wavelengths (e.g., 1.3 μm, 1.55 μm). Other embodiments may be designed for other wavelengths as well.

In another embodiment of the present invention, an optical I/O chip 30 may have multiple layers of optical I/O ports and waveguides in a stacked manner to provide scaling for increases in I/O channels. For example, there may be optical coupling vertically between layers of optical waveguides, similar to the way metal layers are connected in an electronic integrated circuit. It is also contemplated that multiple electronic chips 32 may be electrically coupled to an optical I/O chip 30, and vice versa, multiple optical I/O 30 may be electrically coupled to an electronic chip 32. For example, two electronic chips 32 may be optically coupled to each other via their electrical connections to a mutual optical I/O chip 30.

An embodiment of the present invention may be implemented in a system on a package configuration where several chips are packaged together (e.g., using an interposer-type platform to connect them). Also, a semiconductor substrate interposer may be located between the optical I/O chip 30 and the electronic chip 32, where each of the chips 30, 32 are electrically connected via the semiconductor substrate interposer (e.g., silicon wafer with copper traces). As yet another alternative or variation, wirelines and/or waveguides may be added to a semiconductor substrate interposer, on which one or more electronic chips 32 are attached to provide optical communication to components outside of the package. Hence, the semiconductor substrate interposer may be the optical I/O chip or may act as an additional optical I/O chip.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An optical input/output (I/O) chip adapted to be electrically coupled to a distinct electronic chip, the optical I/O chip comprising:
an optical input port adapted to be optically coupled to an external optical input source and adapted to receive optical input signals into the optical I/O chip from the external optical input source;
an input optical detector optically coupled to the optical input port so that optical input signals entering the optical I/O chip via the optical input port are received by the input optical detector, wherein the input optical detector is adapted to convert optical input signals to respective electrical input signals;
an input electrical contact electrically coupled to the input optical detector, wherein the input electrical contact is adapted to be electrically coupled to the electronic chip for providing electrical input signals thereto;
an output light-source port adapted to be optically coupled to an external light source;
an output optical modulator optically coupled to the output light-source port, the output optical modulator being adapted to convert electrical output signals to respective optical output signals;
an output electrical contact electrically coupled to the output optical modulator, wherein the output electrical contact is adapted to be electrically coupled to the electronic chip for receiving electrical output signals therefrom; and
an optical output port optically coupled to the output optical modulator, wherein the optical output port is adapted to be optically coupled to an external output signal receiving device.

2. The optical I/O chip of claim 1, further comprising:
an input optical waveguide having a first input waveguide end optically coupled to the optical input port, and having a second input waveguide end optically coupled to the input optical detector, such that optical input signals entering the optical I/O chip via the optical input port are received by the input optical detector.

3. The optical I/O chip of claim 1, further comprising:
an output light-source waveguide having a first output light-source waveguide end optically coupled to the output light-source port, and having a second output light-source waveguide end optically coupled to the output optical modulator, such that light from external light source entering the optical I/O chip via the output light-source port is channeled to the output optical modulator via the output light-source waveguide.

4. The optical I/O chip of claim 1, further comprising:
an output optical waveguide having a first output waveguide end optically coupled to the output optical modulator, and having a second output waveguide end optically coupled to the optical output port, such that optical output signals from the output optical modulator are output to the external output signal receiving device via the output optical waveguide.

5. The optical I/O chip of claim 1, wherein the input optical detector is a SiGe planar photodetector device.

6. The optical I/O chip of claim 1, wherein the input optical detector comprises a SiGe absorption region.

7. The optical I/O chip of claim 1, further comprising a transimpedance amplifier electrically coupled between the input optical detector and the input electrical contact.

8. The optical I/O chip of claim 1, wherein the output optical modulator comprises a Mach-Zehnder interferometer with a multiple quantum well.

9. The optical I/O chip of claim 1, further comprising:
an optical clock port adapted to be optically coupled to an external optical clock source and adapted to receive optical clock signals into the optical I/O chip from the external optical clock source;
a clock optical detector optically coupled to the optical clock port so that optical clock signals entering the optical I/O chip via the optical clock port are received by the clock optical detector, wherein the clock optical detector is adapted to convert optical clock signals to respective electrical clock signals; and
a clock electrical contact electrically coupled to the clock optical detector, wherein the clock electrical contact is adapted to be electrically coupled to the electronic chip for providing electrical clock signals thereto.

10. The optical I/O chip of claim 9, further comprising additional clock optical detectors optically coupled to the optical clock port, wherein light from the external optical clock source is fanned out to the clock optical detectors so that the external optical clock source provides light to the clock optical detectors.

11. The optical I/O chip of claim 1, further comprising additional output optical modulators optically coupled to the output light-source port, wherein light from the external light source is fanned out to the output optical modulators so that the external light source provides light to the output optical modulators.

12. An optical input/output (110) chip adapted to be electrically coupled to a distinct electronic chip, the optical I/O chip comprising:
an optical input port adapted to be optically coupled to an external optical input source and adapted to receive optical input signals into the optical I/O chip from the external optical input source;
an input optical waveguide having a first input waveguide end that is optically coupled to the optical input port;
an input optical detector optically coupled to a second input waveguide end of the input optical waveguide, such that optical input signals entering the optical I/O chip via the optical input port are received by the input optical detector, wherein the input optical detector is adapted to convert optical input signals to respective electrical input signals;
an input electrical contact electrically coupled to the input optical detector, wherein the input electrical contact is adapted to be electrically coupled to the electronic chip;
an output light-source port adapted to be optically coupled to an external light source;
an output light-source waveguide having a first output light-source waveguide end that is optically coupled to the output light-source port;
an output optical modulator optically coupled to a second output light-source waveguide end of the output light-source waveguide, the output optical modulator being adapted to convert electrical output signals to respective optical output signals;
an output electrical contact electrically coupled to the output optical modulator, wherein the output electrical contact is adapted to be electrically coupled to the electronic chip;
an output optical waveguide having a first output waveguide end that is optically coupled to the output optical modulator; and
an optical output port adapted to be optically coupled to an external output signal receiving device.

13. The optical I/O chip of claim 12, further comprising a transimpedance amplifier electrically coupled between the input optical detector and the input electrical contact.

14. An optical input/output (I/O) chip adapted to be electrically coupled to a distinct electronic chip, the optical I/O chip comprising:
an optical input port adapted to be optically coupled to an external optical input source and adapted to receive optical input signals into the optical I/O chip from the external optical input source;
an input optical detector optically coupled to the optical input port so that optical input signals entering the optical I/O chip via the optical input port are received by the input optical detector, wherein the input optical detector is adapted to convert optical input signals to respective electrical input signals;
an input electrical contact electrically coupled to the input optical detector, wherein the input electrical contact is adapted to be electrically coupled to the electronic chip for providing electrical input signals thereto;
an output light-source port adapted to be optically coupled to an external light source;
an output optical modulator optically coupled to the output light-source port, the output optical modulator being adapted to convert electrical output signals to respective optical output signals;
an output electrical contact electrically coupled to the output optical modulator, wherein the output electrical contact is adapted to be electrically coupled to the electronic chip for receiving electrical output signals therefrom;
an optical output port optically coupled to the output optical modulator, wherein the optical output port is adapted to be optically coupled to an external output signal receiving device;
an optical clock port adapted to be optically coupled to an external optical clock source adapted to receive optical clock signals into the optical I/O chip from the external optical clock source;
a clock optical detector optically coupled to the optical clock port so that optical clock signals entering the optical I/O chip via the optical clock port are received by the clock optical detector, wherein the clock optical detector is adapted to convert optical clock signals to respective electrical clock signals; and
a clock electrical contact electrically coupled to the clock optical detector, wherein the clock electrical contact is adapted to be electrically coupled to the electronic chip for providing electrical clock signals thereto.

15. The optical I/O chip of claim 14, further comprising a transimpedance amplifier electrically coupled between the clock optical detector and the clock electrical contact.

16. The optical I/O chip of claim 14, further comprising a transimpedance amplifier electrically coupled between the input optical detector and the input electrical contact.

17. An optical input/output (I/O) chip adapted to be electrically coupled to a distinct electronic chip, the optical I/O chip comprising:
an optical I/O port adapted to be optically coupled to at least one external optical component;
an optical coupler optically coupled to the optical I/O port;
an input optical detector optically coupled to the optical coupler so that optical input signals entering the optical I/O chip via the optical input port may be routed to and received by the input optical detector via the optical coupler, wherein the input optical detector is adapted to convert optical input signals to respective electrical input signals;
an input electrical contact electrically coupled to the input optical detector, wherein the input electrical contact is adapted to be electrically coupled to the electronic chip for providing electrical input signals thereto;
an output light-source port adapted to be optically coupled to an external light source;
an output optical modulator optically coupled to the output light-source port, the output optical modulator being adapted to convert electrical output signals to respective optical output signals, the output optical modulator also being optically coupled to the optical coupler such that optical output signals from the output optical modulator may be routed to the optical I/O port via the optical coupler; and
an output electrical contact electrically coupled to the output optical modulator, wherein the output electrical contact is adapted to be electrically coupled to the electronic chip for receiving electrical output signals therefrom.

18. The optical I/O chip of claim 17, further comprising a transimpedance amplifier electrically coupled between the input optical detector and the input electrical contact.

19. The hybrid optical-electronic chip system of claim 17, wherein the optical I/O chip and the electronic chip are located in a same package.

20. The hybrid optical-electronic chip system of claim 19, wherein the optical I/O chip and the electronic chip are electrically connected to and attached to a semiconductor substrate interposer.

21. The hybrid optical-electronic chip system of claim 20, further comprising another electronic chip electrically connected to and attached to the semiconductor substrate interposer.

22. The hybrid optical-electronic chip system of claim 17, wherein the optical I/O chip is a semiconductor substrate interposer having a second distinct electronic chip electrically coupled thereto.

23. The hybrid optical-electronic chip system of claim 22, wherein the optical I/O chip and the electronic chips are located in a same package.

24. The hybrid optical-electronic chip system of claim 17, further comprising a semiconductor substrate interposer, wherein the optical I/O chip and the electronic chip are electrically connected to and attached to a semiconductor substrate interposer, and wherein the optical I/O chip and the electronic chip are electrically connected via the semiconductor substrate interposer.

25. A hybrid optical-electronic chip system comprising:
an electronic chip comprising
an integrated electrical circuit adapted to perform electronic functions,
a first input electrical contact electrically coupled to the integrated electrical circuit, and
a first output electrical contact electrically coupled to the integrated electrical circuit; and
an optical input/output (I/O) chip comprising
an optical input port adapted to be optically coupled to an external optical input source and adapted to receive optical input signals into the optical I/O chip from the external optical input source,
an input optical detector optically coupled to the optical input port so that optical input signals entering the optical I/O chip via the optical input port are received by the input optical detector, wherein the input optical detector is adapted to convert optical input signals to respective electrical input signals,
a second input electrical contact electrically coupled to the input optical detector, wherein the second input electrical contact is electrically coupled to the first input electrical contact of the electronic chip for providing electrical input signals to the electronic chip,
an output light-source port adapted to be optically coupled to an external light source,
an output optical modulator optically coupled to the output light-source port, the output optical modulator being adapted to convert electrical output signals to respective optical output signals,
a second output electrical contact electrically coupled to the output optical modulator, wherein the output electrical contact is electrically coupled to first output electrical contact of the electronic chip for receiving electrical output signals from the electronic chip, and
an optical output port optically coupled to the output optical modulator, wherein the optical output port is adapted to be optically coupled to an external output signal receiving device.

26. The hybrid optical-electronic chip system of claim 25, wherein the first input and output electrical contacts of the electronic chip are electrically coupled to the second input and output electrical contacts of the optical I/O chip, respectively, using a flip-chip arrangement with an array of solder bumps.

27. The hybrid optical-electronic chip system of claim 25, wherein the electronic chip and the optical I/O chip reside on a same printed circuit board.
